(19) United States
(12) Patent Application Publication
(10) Pub. No.: US 2011/0005417 A1
(43) Pub. Date: Jan. 13, 2011

(54) PRINTING PLATE MATERIAL FOR LITHOGRAPHY

(76) Inventors: Saori Sukeda, Saitama (JP); Hironori Sato, Tokyo (JP)

Correspondence Address: KENEALY VAIDYA LLP, 515 EAST BRADDOCK RD SUITE B, Alexandria, VA, 22314, US

(21) Appl. No.: 12/934,566

(22) PCT Filed: Mar. 26, 2009
(86) PCT No.: PCT/JP2009/056056

§ 371 Date: Sep. 24, 2010

(30) Foreign Application Priority Data
Mar. 26, 2008 (JP) 2008-079929

(51) Int. Cl. B41N 1/00

(52) U.S. Cl. 101/453

(57) ABSTRACT

A printing plate material for lithography showing superior balance of suitability for ink-jet printing and printability is provided. A printing plate material for lithography can include a support and an image-receiving layer containing a binder resin and a matting agent and provided on the support and can be constituted so that a hydrophilic resin having an average degree of polymerization of 2500 or higher is contained as the binder resin, and a matting agent showing an oil absorption of 350 ml/100 g or larger can be contained as the matting agent. It can also be constituted so that, as the binder resin, 60% by weight or more of the hydrophilic resin having an average degree of polymerization of 2500 or higher is contained based on the total binder resin. It can also be constituted so that, as the matting agent, 35 to 100 parts by weight of the matting agent showing an oil absorption of 350 ml/100 g or larger is contained for 100 parts by weight of the binder resin.

### TECHNICAL FIELD

The present invention relates to a material for producing a lithographic printing plate (henceforth also referred to as “printing plate”) by using an ink-jet printer.

### BACKGROUND ART

In the lithography, there is used a plate, called PS plate, produced by uniformly applying a photosensitive resin on a surface of an aluminum support. This PS plate (printing original plate) is generally made into a printing plate by many steps including the image drawing step for selectively curing portions corresponding to image lines by laser exposure according to a desired image pattern, the developing step for developing the image with a developer, the rinsing step for washing away the developer, unnecessary photosensitive resin etc., the gum treatment step for coating a solution containing gum arabic, starch derivative or the like for protecting surface of the PS plate, the drying step, and so forth.

In recent years, with development of business machines and progress of OA equipments, there have been proposed direct platemaking methods using output devices such as electrophotographic printers, thermal transfer printers and ink-jet printers, without outputting image signals on printing paper or lithographic film from a computer.

Among the direct platemaking methods, the platemaking methods using an ink-jet printer have characteristics that the apparatuses for the methods can be made smaller etc., and various proposals have been made on the methods (refer to Patent documents 1 and 2).

As a lithographic printing plate material used for the platemaking methods using an ink-jet printer, it is also possible to use such base materials as used for PS plates. However, since base materials used for PS plates do not have a layer suitable for retaining ink on the surfaces thereof, the ink adhered to the surfaces spreads, and therefore it is difficult to form images with high resolution.

On the other hand, a lithographic printing plate material showing superior property for ink-jet printing can be obtained by forming an ink-absorbing layer on the surface of a base material. However, if an image-receiving layer is formed to obtain favorable property for ink-jet printing, there arises a problem that sufficient water cannot be retained on the surface of the printing plate at the time of printing, and thus scumming occurs.

In order to solve this problem, there has been proposed a lithographic printing plate material for a platemaking method using an ink-jet printer, which is designed in consideration of the balance of suitability for ink-jet printing and printability (refer to Patent document 3).
Patent document 1: Japanese Patent Unexamined Publication (KOKAI) No. 56-62157 (claims)
Patent document 2: Japanese Patent Unexamined Publication No. 5-269958 (claims)
Patent document 3: Japanese Patent Unexamined Publication No. 2007-55052 (claims)

### DISCLOSURE OF THE INVENTION

### Problem to be Solved by the Invention

Although a lithographic printing plate material designed by taking balance of suitability for ink-jet printing and printability into consideration has been in fact proposed in Patent document 3, it still shows blur of ink, and therefore it cannot be said to show satisfactory balance of suitability for ink-jet printing and printability.

For reducing this blur of ink, a method of producing a printing plate material by using a highly oil-absorbing matting agent as the matting agent to be contained in the image-receiving layer is conceivable. However, such a method has a problem that it invites reduced water retention to generate scumming etc., and yet cannot provide sufficient printability.

Such problems concerning blur of ink and water retention cannot be sufficiently improved by controlling thickness of the image-receiving layer or type and amount of the matting agent to be contained in the image-receiving layer.

### Means for Solving the Problem

Then, the inventor of the present invention conducted various researches, and as a result, found that, if a hydrophilic resin having an average degree of polymerization of 2500 or higher was used as the binder resin, together with a matting agent showing a high oil absorption, the lithographic printing plate material could be made to show extremely superior balance of suitability for ink-jet printing and printability.

Thus, the lithographic printing plate material of the present invention is a lithographic printing plate material comprising a support and an image-receiving layer containing a binder resin and a matting agent and provided on the support, which contains a hydrophilic resin having an average degree of polymerization of 2500 or higher as the binder resin, and a matting agent showing an oil absorption of 350 ml/100 g or larger as the matting agent.

The lithographic printing plate material of the present invention may be characterized by containing, as the binder resin, 60% by weight or more of the hydrophilic resin having an average degree of polymerization of 2500 or higher based on the total binder resin.

The lithographic printing plate material of the present invention may also be characterized by containing, as the matting agent, 35 to 100 parts by weight of the matting agent showing an oil absorption of 350 ml/100 g or larger for 100 parts by weight of the binder resin.

The lithographic printing plate material of the present invention may also be characterized in that the image-receiving layer contains 1 part by weight or less of a plasticizer for 100 parts by weight of the binder resin. In this case, the binder resin preferably contains a hydrophilic resin having an average degree of polymerization lower than 2500, besides the hydrophilic resin having an average degree of polymerization of 2500 or higher. Ratio of the hydrophilic resin having an average degree of polymerization of 2500 or higher and the hydrophilic resin having an average degree of polymerization lower than 2500 is preferably 10:10 to 13:7 in terms of weight ratio.

### Effect of the Invention

Since the lithographic printing plate material of the present invention is a lithographic printing plate material having an image-receiving layer containing a binder resin and a matting agent on a support, and contains a hydrophilic resin having an average degree of polymerization of 2500 or higher as the binder resin, and a matting agent showing an oil absorption of 350 ml/100 g or larger as the matting agent, it shows superior balance of suitability for ink-jet printing and printability (scumming-preventing property).

Moreover, by adding a plasticizer to the image-receiving layer of the lithographic printing plate material of the present invention, cracking of the image-receiving layer can surely be prevented, which may be caused in the image-receiving layer shrinking as a coated film during coating and drying of the image-receiving layer in the production process of the printing plate material. Moreover, by adding a hydrophilic resin having an average degree of polymerization of 2500 or higher as the binder resin together with a plasticizer, reduction of hydrophilicity of the image-receiving layer induced by addition of the plasticizer can be suppressed, and when the lithographic printing plate material of the present invention is made to a printing plate, scumming of printed matter can be prevented.

### BEST MODE FOR CARRYING OUT THE INVENTION

The lithographic printing plate material of the present invention is a lithographic printing plate material comprising a support and an image-receiving layer containing a binder resin and a matting agent provided on the support, and is characterized by containing a hydrophilic resin having an average degree of polymerization of 2500 or higher as the binder resin, and a matting agent showing an oil absorption of 350 ml/100 g or larger as the matting agent. Embodiments of the constituents thereof will be explained below.

As the support, a plastic film consisting of a resin such as polyethylene, polypropylene, polyvinyl chloride, polystyrene and polyethylene terephthalate, or a waterproof paper sheet in which such a plastic film as mentioned above is laminated on the surface or such a resin as mentioned above is coated on the surface can be used.

In particular, a polyethylene terephthalate film is preferred, since it shows superior mechanical strength, dimensional stability, resistance to chemicals and water resistance. The support may be a film formed from a material in which a concealer pigment such as carbon black or titanium oxide is mixed by kneading, in order to impart an optical shielding effect. Although thickness of the support is not particularly limited, a support having a thickness of 50 to 300 μm is usually used.

In order to improve adhesion to the image-receiving layer, the support may be subjected to a plasma treatment, a corona discharge treatment or a far ultraviolet ray irradiation treatment. An undercoat layer may also be provided as an undercoat treatment for promoting adhesion with the image-receiving layer.

The undercoat layer preferably consists of a resin showing favorable adhesion to both the resins constituting the support and the image-receiving layer. Therefore, although the resin constituting the undercoat layer may differ depending on the resins of the support and the image-receiving layer to be used, examples thereof include polymers or copolymers of vinyl acetate, vinyl chloride, styrene, butadiene, acrylic acid esters, methacrylic acid esters, ethylene, acrylonitrile etc., polyester resins, polyurethane resins, alkyd resins, epoxy resins, polyvinyl alcohol, carboxymethylcellulose, hydroxyethylcellulose, casein, gelatin, water-soluble polyurethane, isocyanate type compounds, and so forth. Any one kind or a combination of two or more kinds of them can be used.

When the image-receiving layer contains a polyvinyl alcohol having an average degree of polymerization of 2500 or higher, which will be described later, as the hydrophilic resin, in particular, it is preferable to use an isocyanate type compound showing good adhesion to the polyvinyl alcohol for the undercoat layer. Although thickness of the undercoat layer is not particularly limited, it is usually about 0.1 to 10 μm.

The image-receiving layer has a function of forming an image by absorbing ink of ink-jet printing to form lipophilic portions and hydrophilic portions on the image-receiving-layer surface and thereby form a printing plate that enables printing. Specifically, image portions become lipophilic to retain printing ink, whereas non-image portions become hydrophilic to retain dampening water and repel printing ink. Such an image-receiving layer consists of at least a binder resin and a matting agent.

The binder resin constituting the image-receiving layer of the present invention contains a hydrophilic resin having an average degree of polymerization of 2500 or higher.

Examples of the hydrophilic resin having an average degree of polymerization of 2500 or higher include polyvinyl alcohol, carboxymethylcellulose, hydroxyethylcellulose, casein, gelatin, water-soluble polyurethane, and so forth. Among them, polyvinyl alcohol, especially polyvinyl alcohol showing a high degree of saponification, is preferred in order to bind the highly oil absorbable matting agent described later, to impart hydrophilicity to the image-receiving layer, etc. The average degree of polymerization of the hydrophilic resin is preferably 3000 or lower, more preferably 2750 or lower.

The binder resin preferably contains 60% by weight or more, more preferably 80% by weight or more, of the hydrophilic resin having an average degree of polymerization of 2500 or higher, based on the total binder resin. By adding 60% by weight or more of the hydrophilic resin having an average degree of polymerization of 2500 or higher as the binder resin based on the total binder resin as described above, the water retention property can be made favorable to improve printability.

The binder resin may contain, besides the hydrophilic resin having an average degree of polymerization of 2500 or higher, a hydrophilic resin having an average degree of polymerization lower than 2500, a resin or crosslinking agent for improving water resistance or film strength of the image-receiving layer, a plasticizer for preventing cracking of the image-receiving layer, and so forth. The plasticizer is preferably contained together with a hydrophilic resin having an average degree of polymerization lower than 2500.

By adding a hydrophilic resin having an average degree of polymerization lower than 2500 as a binder component, even when a plasticizer is added to the image-receiving layer, reduction of hydrophilicity due to the addition can be prevented, and favorable printability can be maintained.

As the hydrophilic resin having an average degree of polymerization lower than 2500, a resin of a type similar to that of the hydrophilic resin having an average degree of polymerization of 2500 or higher can be used, and polyvinyl alcohol is especially preferred, since it makes easier to impart hydrophilicity suitable for printing to the image-receiving layer. The average degree of polymerization thereof is preferably 1800 to 2200 for the same reason.

In addition, when a plasticizer is added to the image-receiving layer, ratio of the hydrophilic resin having an average degree of polymerization of 2500 or higher and the hydrophilic resin having an average degree of polymerization lower than 2500 is preferably 10:10 to 13:7 in terms of weight ratio. By using 10 or more of the hydrophilic resin having an average degree of polymerization of 2500 or higher with 10 of the hydrophilic resin having an average degree of polymerization lower than 2500, the highly oil-absorbable matting agent can be bound, and receiving property for ink for ink-jet printing can be secured. By using 13 or less of the hydrophilic resin having an average degree of polymerization of 2500 or higher with 7 of the hydrophilic resin having an average degree of polymerization lower than 2500, printability can be secured, and cracking can be prevented.

Examples of the plasticizer include plasticizers of phthalic acid ester type, adipic acid ester type, phosphoric acid ester type, trimellitic acid ester type, citric acid ester type, epoxy type, polyester type, polyhydric alcohol type etc. Among these, a plasticizer of the polyhydric alcohol type is preferred, which can impart flexibility without degrading recording characteristics for ink-jet printing.

The plasticizer is preferably added in an amount of 0.4 to 1.0 part by weight based on 100 parts by weight of the total binder components of the image-receiving layer. With an amount of 0.4 part by weight or more, cracking of the image-receiving layer can be prevented. With an amount of 1.0 part by weight or less, decrease of hydrophilicity can be suppressed to prevent scumming.

Examples of the resin and crosslinking agent for improving water resistance and film strength of the image-receiving layer include resins such as melamine resins and epoxy resins, crosslinking agents such as polyisocyanates, aldehyde compounds and silane compounds, and so forth.

The matting agent constituting the image-receiving layer of the present invention is explained below. The image-receiving layer of the present invention contains a matting agent showing an oil absorption of 350 ml/100 g or larger. The oil absorption is measured by the boiled linseed oil method defined in JIS K5101-13-2.

Such a matting agent showing high oil absorption as described above has pores in each particles of the matting agent (small gaps are formed), and has a structure having a large surface area. Therefore, water and ink enter into the pores and are easily absorbed by the matting agent, and thus the matting agent can have superior ink-absorbing property or water retention property.

As such a matting agent, inorganic pigments and organic pigments can be used, and inorganic pigments are preferably used, which can improve ink-absorbing property and water retention property for dampening water as the matting agent itself.

Examples of the inorganic pigment include those of silica, zinc oxide, titanium oxide, clay, kaoline, aluminum hydroxide, alumina, and so forth. Among these, silica is preferred in view of ink-absorbing property or water retention property for dampening water thereof.

The matting agent preferably has a mean particle size of 1 to 12 μm.

If a matting agent having a mean particle size smaller than 1 μm is used, gaps cannot be formed by the matting agent, and therefore the image-receiving layer comes to show poor ink-receiving property.

If a matting agent having a mean particle size larger than 12 μm is used, difference of heights of convex and concave portions on the surface of the image-receiving layer described later becomes large, and the image-receiving layer is likely to be blurred with ink unfavorably.

Although the matting agent may also contain a matting agent showing an oil absorption smaller than 350 ml/100 g, it preferably contains 35 to 100 parts by weight, preferably 45 to 75 parts by weight, of a matting agent showing an oil absorption of 350 ml/100 g or larger with respect to 100 parts by weight of the binder resin.

If 35 to 100 parts by weight of a matting agent showing an oil absorption of 350 ml/100 g or larger is contained with 100 parts by weight of the binder resin as described above, ink is easily absorbed, and therefore blur of ink can be prevented to improve suitability for ink-jet printing.

According to the present invention, by using the hydrophilic resin having an average degree of polymerization of 2500 or higher and a matting agent showing an oil absorption of 350 ml/100 g or larger in combination in the image-receiving layer, balance of suitability for ink-jet printing and printability of the layer can be made favorable. The reason why such an effect can be obtained will be explained below.

First, it can be considered that, by using a matting agent showing high oil absorption (oil absorption of 350 ml/100 g or larger), ink is absorbed by the matting agent, and therefore blur of the ink can be suppressed.

However, there are problems that, even if a matting agent showing high oil absorption is used, blur of ink cannot be sufficiently prevented, and that water retention property becomes unduly high, which makes it difficult to control dampening water to generate scumming.

As for the cause of the blur of ink among the above problems, it is considered that if the average degree of polymerization of the hydrophilic resin contained in the binder resin is lower than 2500, such a resin easily enter into pores existing in each particle of the matting agent. If the pores of the matting agent particles are buried with the resin, the space in the pores that can absorb ink decreases, and ink-absorbing property is degraded. If the ink-absorbing property of the matting agent in the image-receiving layer is degraded as described above, the ink-absorption inside the image-receiving layer is degraded, and thus ink spreads on the surface of the image-receiving layer to cause blur.

Further, as for the cause of the scumming among the aforementioned problems, it is considered that if the average degree of polymerization of the hydrophilic resin contained in the binder resin is lower than 2500, even if it is desired to make the image-receiving layer contain much matting agent, the binder resin cannot retain the matting agent, and the matting agent deposits on the surface of the image-receiving layer in the form of powder. The matting agent depositing on the surface of the image-receiving layer in the form of powder is in a state that surface of the matting agent is not covered with the binder resin at all. Therefore, the image-receiving layer surface comes to easily absorb extremely much water. That is, the matting agent depositing on the surface of the image-receiving layer in the form of powder makes the water retention property unduly high. Therefore, supply of dampening water thereby becomes insufficient to cause scumming.

However, if a hydrophilic resin having a high average degree of polymerization is used as the binder resin together with a matting agent showing high oil absorption, it becomes difficult for such a resin to enter into the pores existing in each particle of the matting agent. If the pores of the matting agent particles are not filled with the resin as described above, space that can absorb ink can be secured in the pores, and the ink-absorbing property of the matting agent itself can be secured. Thus, it becomes possible to form the image-receiving layer so that the pores existing in each particle of the matting agent should not be filled with the resin. If the ink-absorbing property of the matting agent in the image-receiving layer is secured as described above, the ink-absorption inside the image-receiving layer is improved, and ink that remains on the surface of the image-receiving layer to cause blur can be reduced. In this way, the image-receiving layer can be formed without degrading the superior ink-absorbing property of the matting agent, and ink that penetrates into the image-receiving layer can be made to be easily absorbed.

Furthermore, the binder resin comes to be able to retain a lot of matting agent, and the image-receiving layer can be formed without powdery surface. Therefore, the surface of the image-receiving layer can have appropriate water retention property and can prevent scumming.

In this way, excessive water retention property of the surface of the image-receiving layer can be prevented to improve the printability. Moreover, ink that penetrates into the image-receiving layer can be made easily absorbed into the image-receiving layer to improve suitability for ink-jet printing. As a result, the balance of suitability for ink-jet printing and printability can be improved.

The image-receiving layer preferably contains microparticles having a mean particle size smaller than 0.5 μm, in addition to the matting agent. By adding such microparticles, it can be made easier to control ink-absorbing property and water retention property for dampening water.

As the microparticles, inorganic microparticles and plastic beads can be used, and inorganic microparticles are preferably used in view of ink-absorbing property or water retention property for dampening water.

Examples of the inorganic microparticles include those of silica, zinc oxide, titanium oxide, clay, kaoline, aluminum hydroxide, alumina, and so forth. Among these, titanium oxide microparticles are preferred in view of ink-absorbing property or water retention property for dampening water.

The microparticles are preferably contained in an amount of 150 to 500 parts by weight with respect to 100 parts by weight of the binder resin in the image-receiving layer.

As for surface profile of the image-receiving layer, it preferably show an arithmetic mean roughness (Ra) of 0.9 μm or smaller, preferably 0.8 μm or smaller, according to JIS B0601:1994. With an arithmetic mean roughness (Ra) of 0.9 μm or smaller, difference of heights of convex and concave portions on the surface of the image-receiving layer can be made small, thus the ink can be prevented from flowing from convex portions to concave portions to cause blur of images, and at the same time, non-image portions can be uniformly made hydrophilic with dampening water to prevent generation of scumming at the time of printing.

Furthermore, as for surface profile of the image-receiving layer, it also preferably shows a mean spacing of local peaks of the profile (S) of 60 μm or larger, preferably 75 μm or larger, according to JIS B0601:1994. With a mean spacing of local peaks of the profile (S) of 60 μm or larger, convex portions on the surface of the image-receiving layer can be made fewer, thus ink can be prevented from flowing from convex portions to concave portions to cause blur of images. At the same time, increase of surface area of the image-receiving layer can be prevented so that absorbing property for dampening water is kept from becoming unduly high and thereby generation of scumming due to insufficiency of water on the surface of a printing plate at the time of printing can be prevented.

The image-receiving layer preferably has a thickness of 8 to 20 μm, more preferably 10 to 15 μm. With a thickness of 8 μm or larger, suitability for ink-jet printing and printability can be made favorable, and with a thickness of 20 μm or smaller, absorbing property for dampening water can be prevented from becoming unduly high to prevent generation of scumming due to insufficiency of water on the surface of a printing plate at the time of printing.

The aforementioned undercoat layer and image-receiving layer may contain additives, for example, colorants such as dyes and pigments, leveling agents, ultraviolet absorbers, anti-oxidants etc., in such a range that the aforementioned performance should not be degraded.

Examples of the method for forming the undercoat layer or the image-receiving layer include a method of dissolving or dispersing constituents of each layer in a suitable solvent to form a coating solution, applying the coating solution on a support or an undercoat layer by a known method such as roll coating method, bar coating method, spray coating method and air knife coating method, and drying it.

The lithographic printing plate material of the present invention is made into a printing plate by outputting lipophilic ink thereon by the ink-jet recording method to form a lipophilic image. When an ionizing radiation curable resin is used as the resin constituting the lipophilic ink, the material is irradiated with ionizing radiation after the output and thereby made into a printing plate. In a printing plate obtained as described above, image portions serves as ink-receiving portions that repel water and accept printing ink, and non-image portions where image is not formed serve as hydrophilized portions that accept dampening water and repel ink, after an etching treatment is carried out as required.

The lipophilic ink consists of at least a lipophilic resin and a solvent, and it preferably contains a color pigment for confirmation of images after the output.

Examples of the lipophilic resin include thermoplastic resins, thermosetting resins, ionizing radiation curable resins, and so forth, such as polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins and silicone resins. Among these, ionizing radiation curable resins such as polyester acrylate resins, polyurethane acrylate resins and epoxy acrylate resins can be preferably used, which enable sufficient curing of the ink to provide favorable printing durability as a printing plate.

### EXAMPLES

Hereafter, the present invention will be explained with reference to examples. The term “part” and the symbol “%” are used on weight basis, unless especially indicated.

### Example 1

On a support consisting of a polyester film having a thickness of 188 μm, a coating solution for undercoat layer having the following composition was applied by the bar coating method so as to obtain a dry film thickness of 2 μm to form an undercoat layer.

<Coating solution for undercoat layer>

| | |
|---|---|
| Polyester resin (Elitel UE3201, | 10 parts |
| Unitika, Ltd., solid content: 100%) | |
| Isocyanate prepolymer (Takenate D110N, | 2 parts |
| Mitsui Chemicals Polyurethane, Inc., | |
| solid content: 60%) | |
| Toluene | 40 parts |
| Methyl ethyl ketone | 40 parts |

Then, a coating solution for image-receiving layer having the following composition was applied on the undercoat layer, and dried to form an image-receiving layer having a thickness of 12 μm, and thereby obtain a lithographic printing plate material of Example 1.

<Coating solution for image-receiving layer>

| | |
|---|---|
| Polyvinyl alcohol (Gohsenol NH26, | 75 parts |
| The Nippon Synthetic Chemical Industry Co., Ltd., | |
| solid content: 5%, average degrees of polymerization: | |
| 2500 to 2650) | |
| Isopropyl alcohol | 3 parts |
| Distilled water | 40 parts |
| Matting agent (silica, Nipgel AZ-204, | 2.2 parts |
| TOSOH SILICA CORPORATION, | |
| oil absorption: 355 ml/100 g, | |
| mean particle diameter: 1.3 μm) | |
| Microparticles (titanium oxide, | 11 parts |
| TIPAQUE A100, Ishihara Sangyo Kaisha, Ltd., | |
| mean particle diameter: 0.4 μm) | |

### Example 2

A lithographic printing plate material of Example 2 was obtained in the same manner as that of Example 1, except that 25 parts of polyvinyl alcohol having an average degrees of polymerization of 2000 (Gohsenol NH20, The Nippon Synthetic Chemical Industry Co., Ltd., solid content: 5%) was added in addition to 75 parts of the polyvinyl alcohol having an average degree of polymerization of 2500 to 2650 in the coating solution for image-receiving layer of Example 1.

### Example 3

A lithographic printing plate material of Example 3 was obtained in the same manner as that of Example 1, except that the amount of the matting agent showing an oil absorption of 355 ml/100 g in the coating solution for image-receiving layer of Example 1 (2.2 parts) was changed to 3.75 parts.

### Example 4

A lithographic printing plate material of Example 4 was obtained in the same manner as that of Example 1, except that the amount of the matting agent showing an oil absorption of 355 ml/100 g in the coating solution for image-receiving layer of Example 1 (2.2 parts) was changed to 1.32 parts.

### Comparative Example 1

A lithographic printing plate material of Comparative Example 1 was obtained in the same manner as that of Example 1, except that the polyvinyl alcohol having an average degree of polymerization of 2500 to 2650 in the coating solution for image-receiving layer of Example 1 was changed to polyvinyl alcohol having an average degree of polymerization of 2000 (Gohsenol NH20, The Nippon Synthetic Chemical Industry Co., Ltd., solid content: 5%).

### Comparative Example 2

A lithographic printing plate material of Comparative Example 2 was obtained in the same manner as that of Example 1, except that the polyvinyl alcohol having an average degree of polymerization of 2500 to 2650 in the coating solution for image-receiving layer of Example 1 was changed to polyvinyl alcohol having an average degree of polymerization lower than 2000 (Gohsenol MM11, The Nippon Synthetic Chemical Industry Co., Ltd., solid content: 5%).

### Comparative Example 3

A lithographic printing plate material of Comparative Example 3 was obtained in the same manner as that of Example 1, except that the matting agent showing an oil absorption of 355 ml/100 g in the coating solution for image-receiving layer of Example 1 was changed to a matting agent showing an oil absorption of 340 ml/100 g (Nipgel AZ-201, TOSOH SILICA CORPORATION, mean particle diameter: 1.7 μm).

### Comparative Example 4

A lithographic printing plate material of Comparative Example 4 was obtained in the same manner as that of Example 1, except that the matting agent showing an oil absorption of 355 ml/100 g in the coating solution for image-receiving layer of Example 1 was changed to a matting agent showing an oil absorption of 250 ml/100 g (Nipgel AY-420, TOSOH SILICA CORPORATION, mean particle diameter: 3.0 μm).

### Comparative Example 5

A lithographic printing plate material of Comparative Example 5 was obtained in the same manner as that of Example 1, except that the polyvinyl alcohol having an average degree of polymerization of 2500 to 2650 in the coating solution for image-receiving layer of Example 1 was changed to polyvinyl alcohol having an average degrees of polymerization of 2000 (Gohsenol NH20, The Nippon Synthetic Chemical Industry Co., Ltd., solid content: 5%), and the matting agent showing an oil absorption of 355 ml/100 g was changed to a matting agent showing an oil absorption of 340 ml/100 g (Nipgel AZ-201, TOSOH SILICA CORPORATION).

Then, the lithographic printing plate materials obtained in Examples 1 to 4 and Comparative Examples 1 to 5 were evaluated for the following items. The results are shown in Table 1.

### (1) Blur of Image (Suitability for Ink-Jet Printing)

An image was outputted on the lithographic printing plate materials obtained in Examples 1 to 4 and Comparative Examples 1 to 5 by using an ink-jet printer with an ionizing radiation curable resin as an ink component to obtain lithographic printing plates. The result that no blur of images was observed on the lithographic printing plate was indicated with the symbol “◯”, the result that blur was slightly observed, but characters of 5 points or larger were clearly readable was indicated with the symbol “Δ”, and the result that blur was significant, and even characters of 5 points or larger were not readable is indicated with the symbol “×”.

### (2) Scumming (Printability)

The lithographic printing plate materials obtained in Examples 1 to 4 and Comparative Examples 1 to 5 on which no image was printed were each mounted on an offset press (RYOBI 3200ACD, Ryobi, Ltd.), and printing was performed. The number of sheets printed until scumming came to be no longer generated was evaluated. The result that scumming came to be no longer generated during printing of less than 20 sheets was indicated with the score “5”, the result that scumming came to be no longer generated during printing of 20 sheets or more but less than 30 sheets was indicated with the score “4”, the result that scumming came to be no longer generated during printing of 30 sheets or more but less than 40 sheets was indicated with the score “3”, the result that scumming came to be no longer generated during printing of 40 sheets or more but less than 50 sheets was indicated with the score “2”, and the result that printing of 50 sheets or more was required until scumming came to be no longer generated was indicated with the score “1”.

TABLE 1

| | Suitability for | |
|---|---|---|
| | ink-jet printing | Printability |
| | Blur | Scumming |
| Example 1 | ◯ | 5 |
| Example 2 | ◯ | 4 |
| Example 3 | ◯ | 4 |
| Example 4 | ◯ | 4 |
| Comparative | Δ | 2 |
| Example 1 | | |
| Comparative | Δ | 1 |
| Example 2 | | |
| Comparative | Δ | 4 |
| Example 3 | | |
| Comparative | X | 4 |
| Example 4 | | |
| Comparative | X | 2 |
| Example 5 | | |

As clearly seen from the results shown in Table 1, since the lithographic printing plate materials of Examples 1 to 4 were formed by mixing a binder resin containing a hydrophilic resin having an average degree of polymerization of 2500 or higher and a matting agent showing an oil absorption larger than 350 ml/100 g, they showed good results for both blur and scumming. Moreover, they showed no variation of dots of ink-jet printing, and superior gradation expression.

Further, the lithographic printing plate material of Example 1 contained 100% of the hydrophilic resin having an average degree of polymerization of 2500 or higher in the total binder resin, and 2.2 parts of a matting agent showing an oil absorption larger than 350 ml/100 g, and therefore it showed improved balance of water retention and supply of dampening water, and thus showed improved scumming. Therefore, it showed further superior printability.

On the other hand, the lithographic printing plate materials of Comparative Examples 1 and 2 used a polyvinyl alcohol having an average degree of polymerization of 2000 or lower. Therefore, although they used a matting agent showing an oil absorption larger than 350 ml/100 g, they both showed poor results for blur and scumming.

Moreover, the lithographic printing plate materials of Comparative Examples 3 and 4 contained a matting agent showing an oil absorption smaller than 350 ml/100 g. Therefore, although they used a polyvinyl alcohol having an average degree of polymerization 2500 or larger, they both showed poor results for blur.

Further, since the lithographic printing plate material of Comparative Example 5 used a polyvinyl alcohol having an average degree of polymerization of 2000 and contained a matting agent showing an oil absorption of 340 ml/100 g, it showed poor results for blur and scumming.

As clearly seen from the results of the above examples, according to the present invention, a synergistic effect for improving balance of suitability for ink-jet printing and printability of a lithographic printing plate material can be obtained, and a favorable lithographic printing plate material can be obtained.

### Example 5

A lithographic printing plate material of Example 5 was obtained in the same manner as that of Example 1, except that 0.8 part of polypropylene glycol was added to the coating solution for image-receiving layer of Example 1 as a plasticizer.

### Example 6

A lithographic printing plate material of Example 6 was obtained in the same manner as that of Example 2, except that 0.6 part of polypropylene glycol was added to the coating solution for image-receiving layer of Example 2 as a plasticizer.

### Example 7

A lithographic printing plate material of Example 7 was obtained in the same manner as that of Example 3, except that 0.8 part of polypropylene glycol was added to the coating solution for image-receiving layer of Example 3 as a plasticizer.

### Example 8

A lithographic printing plate material of Example 8 was obtained in the same manner as that of Example 4, except that 0.8 part of polypropylene glycol was added to the coating solution for image-receiving layer of Example 4 as a plasticizer.

### Example 9

A lithographic printing plate material of Example 9 was obtained in the same manner as that of Example 2, except that 0.4 part of polypropylene glycol was added to the coating solution for image-receiving layer of Example 2 as a plasticizer.

### Example 10

A lithographic printing plate material of Example 10 was obtained in the same manner as that of Example 2, except that 1.0 part of polypropylene glycol was added to the coating solution for image-receiving layer of Example 2 as a plasticizer.

The lithographic printing plate materials of Examples 5 to 10 were evaluated for blur and scumming by the aforementioned evaluation methods. Moreover, they were also evaluated for “cracking” as follows, and the evaluation results are shown in Table 2.

### (3) Cracking

The lithographic printing plate materials obtained in Examples 1 to 10 were each cut into the A4 size, and image lines having a thickness of 50 μm were printed on the whole surfaces of them at intervals of 50 μm by using an ink-jet printer with an ionizing radiation curable resin as an ink component. Then, areas of the A4 size of these lithographic printing plate materials were observed, and portions where image lines were connected due to cracking were counted. When number of the connected portion is 1 or less, the result was indicated with the symbol “⊚”, the results of 2 to 5 connected portions was indicated with the symbol “◯”, and the results of 6 or more connected portions was indicated with the symbol “Δ”.

TABLE 2

| | Blur | Scumming | Cracking |
|---|---|---|---|
| Example 5 | ◯ | 4 | ⊚ |
| Example 6 | ◯ | 4 | ⊚ |
| Example 7 | ◯ | 3 | ⊚ |
| Example 8 | ◯ | 3 | ⊚ |
| Example 9 | ◯ | 4 | ∘ |
| Example 10 | ◯ | 4 | ⊚ |

As clearly seen from the results shown in Table 2, the lithographic printing plate materials obtained in Examples 5 to 10 showed favorable results for blur, like the lithographic printing plate materials of Examples 1 to 4. As for cracking, whereas the lithographic printing plate materials of Examples 1 to 4 all showed results indicated with the symbol “Δ”, which are not shown in Table 2, marked improvement was observed in the lithographic printing plate materials of Examples 5 to 10 obtained by adding the plasticizer, and they all showed good results.

As for scumming, the lithographic printing plate materials of Examples 5, 7 and 8, which corresponded to those of Examples 1, 3 and 4 added with the plasticizer, showed poorer results compared with those of Examples 1, 3 and 4, since hydrophilicity of them is lowered under the influence of the plasticizer compared with those of Examples 1, 3 and 4, which were not added any plasticizer. On the other hand, since the lithographic printing plate materials of Examples 6, 9 and 10, which corresponded to that of Example 2 added with the plasticizer, contained the hydrophilic resin having an average degree of polymerization lower than 2500 in addition to the hydrophilic resin having an average degree of polymerization higher than 2500, they did not show lowering of hydrophilicity, and thus provided results equivalent to those obtained with the lithographic printing plate material of Example 2. In the lithographic printing plate materials of Examples 6, 9 and 10, the content of the plasticizer was changed to 0.6, 0.4 and 1.0 part by weight with respect to 100 parts by weight of the binder resin. Thus, it was confirmed that scumming could be suppressed, and cracking could be prevented with an amount of plasticizer in such a range.

1. A printing plate material for lithography comprising a support and an image-receiving layer containing a binder resin and a matting agent and provided on the support, which contains a hydrophilic resin having an average degree of polymerization of 2500 or higher as the binder resin, and a matting agent showing an oil absorption of 350 ml/100 g or larger as the matting agent.

2. The printing plate material for lithography according to claim 1, which contains, as the binder resin, 60% by weight or more of the hydrophilic resin having an average degree of polymerization of 2500 or higher based on the total binder resin.

3. The printing plate material for lithography according to claim 1, which contains, as the matting agent, 35 to 100 parts by weight of the matting agent showing an oil absorption of 350 ml/100 g or larger for 100 parts by weight of the binder resin.

4. The printing plate material for lithography according to claim 1, wherein the image-receiving layer contains a plasticizer.

5. The printing plate material for lithography according to claim 4, wherein the plasticizer is a polyhydric alcohol type plasticizer.

6. The printing plate material for lithography according to claim 4, wherein the image-receiving layer contains a hydrophilic resin having an average degree of polymerization lower than 2500 as a binder resin.

7. The printing plate material for lithography according to claim 6, wherein ratio of the hydrophilic resin having an average degree of polymerization of 2500 or higher and the hydrophilic resin having an average degree of polymerization lower than 2500 contained in the image-receiving layer is in the range of 10:10 to 13:7 in terms of weight ratio.

8. The printing plate material for lithography according to claim 1, wherein the binder resin is polyvinyl alcohol.

9. The printing plate material for lithography according to claim 1, wherein the matting agent is silica.

10. The printing plate material for lithography according to claim 1, wherein the image-receiving layer contains microparticles having a mean particle size of 0.5 μm or smaller in addition to the matting agent.

11. The printing plate material for lithography according to claim 1, which has an undercoat layer between the support and the image-receiving layer.

12. The printing plate material for lithography according to claim 2, which contains, as the matting agent, 35 to 100 parts by weight of the matting agent showing an oil absorption of 350 ml/100 g or larger for 100 parts by weight of the binder resin.

13. The printing plate material for lithography according to claim 5, wherein the image-receiving layer contains a hydrophilic resin having an average degree of polymerization lower than 2500 as a binder resin.

14. The printing plate material for lithography according to claim 13, wherein ratio of the hydrophilic resin having an average degree of polymerization of 2500 or higher and the hydrophilic resin having an average degree of polymerization lower than 2500 contained in the image-receiving layer is in the range of 10:10 to 13:7 in terms of weight ratio.
